(19) United States
(12) Patent Application Publication
(10) Pub. No.: US 2023/0118259 A1
(43) Pub. Date: Apr. 20, 2023

(54) LABOR SUPPORT APPARATUS AND METHOD

(71) Applicant: Hitachi, Ltd., TOKYO (JP)

(72) Inventors: Keisuke FUKUMOTO, Tokyo (JP); Yasutomo KAWAKAMI, Tokyo (JP)

(73) Assignee: Hitachi, Ltd., Tokyo (JP)

(21) Appl. No.: 17/901,410

(22) Filed: Sep. 1, 2022

(30) Foreign Application Priority Data
Oct. 19, 2021 (JP) 2021-170640

(51) Int. Cl. G06Q 10/06

(52) U.S. Cl. CPC G06Q 10/06311

(57) ABSTRACT

There is provided a labor support apparatus and method capable of supporting a safe, secured, efficient, and comfortable way of working from a user's point of view. A labor support apparatus for supporting a user's labor and a labor support method executed by the labor support apparatus, which are designed to select a workplace suited for the user on the basis of the user' environment and schedule and the user's work status in the past and propose the selected workplace to the user. Accordingly, it is possible to propose an optimum labor location for the user and thereby realize the labor support apparatus and method capable of supporting the safe, secured, efficient, and comfortable way of working from the user's point of view.

### TECHNICAL FIELD

The present invention relates to a labor support apparatus and method and is suited for application to a labor support system which proposes a workplace and working hours suited for a user.

### BACKGROUND ART

In recent years, companies which allow their employees to work at places other than their working place office due to diversification of working arrangements have been increasing. Also, the spread of COVID-19 in recent years has activated the introduction of remote work. Under such circumstances, it is desired to realize a system for comprehensively supporting diverse ways of working.

PTL 1 discloses, as a conventional technique relating to this type of system, a schedule adjustment server designed to “perform crowdedness status adjustment processing when a crowdedness status during a user's working time slot is perceived based on, for example, the user's information and information about the crowdedness status of trains or the like in the past which is acquired from an external service provider and the user is going to commute to office in a crowded state, and when there is a vacancy in a shared office in the vicinity of the current location based on shared office information from the external service provider.”

### CITATION LIST

### Patent Literature

PTL 1: WO2020/256116

### SUMMARY OF THE INVENTION

### Problems to be Solved by the Invention

However, PTL 1 only discloses to propose the user's working hours and their workplace on the basis of the crowdedness status of a commuting route and the shared office.

Therefore, according to the technique disclosed in PTL 1, it is possible to secure the user's safety and sense of security to some extent, but there is a problem of the incapability to propose a comprehensive labor environment which is safe, secured, efficient, and comfortable from the user's point of view.

The present invention was devised in consideration of the above-described circumstances and aims at proposing a labor support apparatus and method capable of supporting the safe, secured, efficient, and comfortable way of working from the user's point of view.

### Means to Solve the Problems

In order to solve the above-described problems, there is provided according to the present invention a labor support apparatus for supporting a user's labor, wherein the labor support apparatus includes: a workplace selection unit that selects a workplace suited for the user on the basis of the user's environment and schedule and the user's work status in past; and a proposal unit that proposes the workplace selected by the workplace selection unit to the user.

Furthermore, there is provided according to the present invention a labor support method executed by the labor support apparatus for supporting the user's labor, wherein the labor support method includes: a first step of selecting a workplace suited for the user on the basis of the user's environment and schedule and the user's work status in past; and a second step of proposing the selected workplace to the user.

The labor support apparatus and method according to the present invention makes it possible to propose the optimum workplace for the user.

### Advantageous Effects of the Invention

The labor support apparatus and method capable of supporting the safe, secured, efficient, and comfortable way of working from the user's point of view can be realized according to the present invention.

### BRIEF DESCRIPTION OF DRAWINGS

FIG. 1 is a block diagram illustrating an overall configuration of a labor support system according to this embodiment;

FIG. 2 is a block diagram illustrating various kinds of programs and various kinds of tables which are stored in a storage apparatus for the labor support apparatus;

FIG. 3 is a chart illustrating a configuration example of a user management table;

FIG. 4 is a chart illustrating a configuration example of a workplace management table;

FIG. 5 is a chart illustrating a configuration example of a user's set score management table;

FIG. 6 is a chart illustrating a configuration example of a work result information table;

FIG. 7 is a chart illustrating a configuration example of a stress-degree-and-smiling-degree information table;

FIG. 8 is a chart illustrating a configuration example of a past workplace information table;

FIG. 9 is a chart illustrating a configuration example of a workplace-and-working-hours-proposing screen;

FIG. 10 is a flowchart illustrating a processing sequence for labor support service provision processing;

FIG. 11 is a chart illustrating a configuration example of a recommendation-condition-and-score table;

FIG. 12 is a flowchart illustrating a processing sequence for first recommendation-condition-and-score decision processing;

FIG. 13 is a chart for explaining the first recommendation-condition-and-score decision processing;

FIG. 14 is a chart illustrating a configuration example of a weather recommendation score table;

FIG. 15 is a flowchart illustrating a processing sequence for second recommendation-condition-and-score decision processing;

FIG. 16 is a chart for explaining the second recommendation-condition-and-score decision processing;

FIG. 17 is a chart illustrating a configuration example of a service-status-based score management table;

FIG. 18 is a flowchart illustrating a processing sequence for third recommendation-condition-and-score decision processing;

FIG. 19 is a chart for explaining the third recommendation-condition-and-score decision processing;

FIG. 20 is a flowchart illustrating a processing sequence for fourth recommendation-condition-and-score decision processing;

FIG. 21 is a chart for explaining fourth recommendation-condition-and-score decision processing;

FIG. 22 is a flowchart illustrating a processing sequence for fifth recommendation-condition-and-score decision processing;

FIG. 23 is a chart for explaining the fifth recommendation-condition-and-score decision processing;

FIG. 24 is a flowchart illustrating a processing sequence for sixth recommendation-condition-and-score decision processing;

FIG. 25 is a flowchart illustrating a processing sequence for seventh recommendation-condition-and-score decision processing;

FIG. 26 is a flowchart illustrating a processing sequence for eighth recommendation-condition-and-score decision processing;

FIG. 27A is a chart for explaining an update of the recommendation-condition-and-score table as associated with the recommendation-condition-and-score decision processing;

FIG. 27B is a chart for explaining an update of the recommendation-condition-and-score table as associated with the recommendation-condition-and-score decision processing;

FIG. 27C is a chart for explaining an update of the recommendation-condition-and-score table as associated with the recommendation-condition-and-score decision processing;

FIG. 28 is a flowchart illustrating a processing sequence for workplace selection processing;

FIG. 29 is a chart illustrating a configuration example of an extracted workplace score table;

FIG. 30A is a chart for explaining an update of the extracted workplace score table as associated with the workplace selection processing;

FIG. 30B is a chart for explaining an update of the extracted workplace score table as associated with the workplace selection processing;

FIG. 31 is a flowchart illustrating a processing sequence for extracted workplace processing;

FIG. 32 is a flowchart illustrating a processing sequence for working hours selection processing;

FIG. 33 is a chart for explaining the working hours selection processing; and

FIG. 34 is a flowchart illustrating a processing sequence for stress-degree-and-smiling-degree measurement processing.

### DESCRIPTION OF EMBODIMENTS

An embodiment of the present invention will be described below in detail with reference to the drawings.

### (1) Configuration of Labor Support System According to this Embodiment

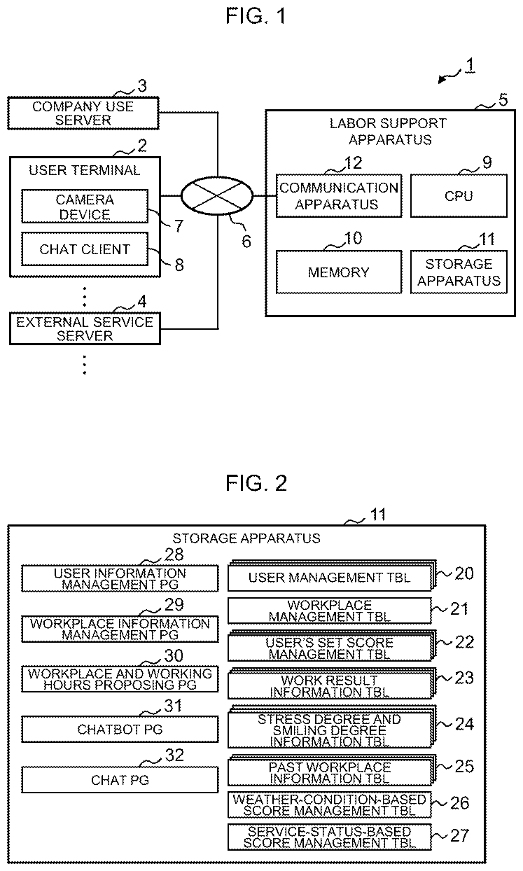

Referring to FIG. 1, the reference numeral “1” represents a labor support system according to this embodiment as a whole. This labor support system 1: includes one or a plurality of user terminals 2, a company use server 3, one or a plurality of external service servers 4, and a labor support apparatus 5; and is configured so that the user terminal(s) 2, the company use server 3, the external service server(s) 4, and the labor support apparatus 5 are connected to each other via a network 6.

The user terminal 2 is a computer device lent to a worker who works for a company or a civil service office that uses labor support services described later and provided by the labor support apparatus 5 (hereinafter referred to as the “company or the like”) and who actually uses such labor support services (hereinafter referred to as the “user”). The user terminal 2 is configured from, for example, a laptop-type personal computer device or a tablet which is equipped with a camera device 7 in addition to a CPU (Central Processing Unit), a memory, a communication device, a display device such as a display, and so on which are not illustrated in the drawing. The user terminal 2 is equipped with a chat client 8 for exchanging chat messages with the labor support apparatus 5.

The company use server 3: is a service apparatus used by the company or the like which receives the provision of the labor support services; and manages schedules of respective users who works there, members belonging to each organization in the company or the like (such as each department, division, and team), a monthly budget and a cost used for the monthly budget, and other KPI (Key Performance Indicators). Incidentally, in this embodiment, the company use server 3 manages desired attendance rates and actual attendance rates at present point in time of the respective organizations as the KPI.

The external service server 4 is a server apparatus retained or used by each external service provider such as the Meteorological Agency or each private weather forecast company, each public transportation company, and a company operating each service office available to users who use the labor support services. The external service server 4 provides the labor support apparatus 5 with weather information, service status information and crowdedness information of public transportation such as trains or busses operated by its own company, or information such as a current crowdedness status and a future crowdedness forecast of service offices operated by its own company in response to a request.

The labor support apparatus 5 is configured from a general-purpose server apparatus equipped with information processing resources such as a CPU 9, a memory 10, a storage apparatus 11, and a communication apparatus 12.

The CPU 9 is a processor which controls actions of the entire labor support apparatus 5. Moreover, the memory 10 is configured from, for example, a volatile semiconductor memory and is used as a work memory for the CPU 9. Various kinds of programs stored in the storage apparatus 11 described later are loaded from the storage apparatus 11 to the memory 10 upon the activation of the labor support apparatus 5 or whenever necessary and the CPU 9 executes the programs which have been loaded to the memory 10, and various kinds of processing is thereby executed as the entire labor support apparatus 5 as described later.

The storage apparatus 11 is configured from a nonvolatile, large-capacity storage apparatus such as a hard disk drive or an SSD (Solid State Drive) and stores the various kinds of programs and data which need to be saved for a long period of time. Moreover, the communication apparatus 12 is configured from, for example, an NIC (Network Interface Card) and performs protocol control when communicating with the user terminal 2 and the external service server 4 via the network 6.

### (2) Labor Support Service Function

Next, a labor support service function mounted in the labor support apparatus 5 will be explained. When there are a plurality of workplaces available to a user who uses the labor support services provided by the labor support apparatus 5, this labor support service function is a function that: proposes today's workplace and working hours which are optimum for the user, to the user on the basis of a today's weather condition, a service status and crowdedness status of public transportation used by the user, the user's future schedule, and so on; and book a workplace designated by the user from among some proposed workplaces in accordance with working hours approved by the user.

Incidentally, the “workplace and working hours which are optimum for the user” mean the workplace where the safe, secured, efficient, and comfortable way of working from the user's point of view can be implemented, and a travel time slot to travel to that workplace. The words “safe, secured” means a reduction of the risk of infection with an infective disease, a reduction of the risk of disasters during commute by avoiding traveling under severe weather conditions such as a strong wind, a heavy rain, or a high temperature, and the prevention of occurrence of psychological fatigue and psychological confusions by avoiding travelling under the environment of, for example, a suspended service, a delayed state, or a crowded state of the public transportation. Also, the word “efficient” means the enhancement of work efficiency of the individual user and the entire team to which the user belongs when the budget and the desired attendance rate of the organization to which the user belongs are observed. Furthermore, the “comfortable way of working” means to work at a workplace with low stress and many smiling faces.

As means for realizing the above-described labor support service function, the storage apparatus 11 for the labor support apparatus 5 stores, as illustrated in FIG. 2, a user management table 20, a workplace management table 21, a users set score management table 22, a work result information table 23, a stress-degree-and-smiling-degree information table 24, a past workplace information table 25, a weather-condition-based score management table 26, and a service-status-based score management table 27 as well as a user information management program 28, a workplace information management program 29, a workplace-and-working-hours-proposing program 30, a chatbot program 31, and a chat program 32.

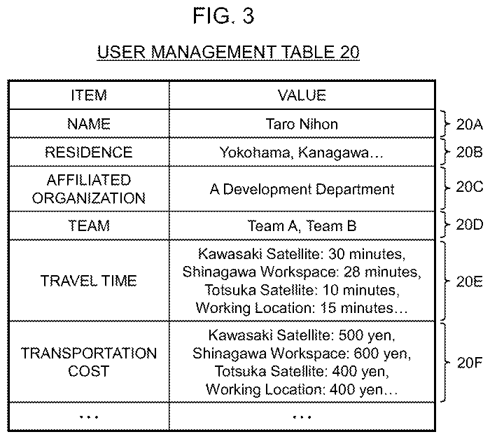

The user management table 20 is a table used to manage various kinds of information regarding each user registered in the labor support apparatus 5 in advance and is created for each user. This user management table 20 is configured by including, as illustrated in FIG. 3, for example, a name column 20A, a residence column 20B, an affiliated organization column 20C, a team column 20D, a travel time column 20E, and a transportation cost column 20F.

Then, the name column 20A stores the name of the relevant user; and the residence column 20B stores the user's home address. Moreover, the affiliated organization column 20C stores an organization name of the organization such as a department or a division to which the user belongs; and the team column 20D stores team names of all teams to which the user currently belongs.

Furthermore, the travel time column 20E stores travel time from home to each workplace available to the user as described later; and the transportation cost column 20F stores a transportation cost from home to each of these workplaces.

Therefore, in a case of an example in FIG. 3, it is shown that the home address of a user whose name is “Taro Nihon” and who belongs to “A Development Department” of a company for which the user works is “ . . . Yokohama, Kanagawa”; the user belongs to teams called “team A” and “team B” for the development, etc.; the travel time from home to “Kawasaki Satellite,” “Shinagawa Workspace,” “Totsuka Satellite,” “Working Location,” and so on which are available as workplaces to the user is “30 minutes,” “28 minutes,” “10 minutes,” and “15 minutes,” respectively, and the transportation cost is “500 yen,” “600 yen,” “400 yen,” and “400 yen,” respectively.

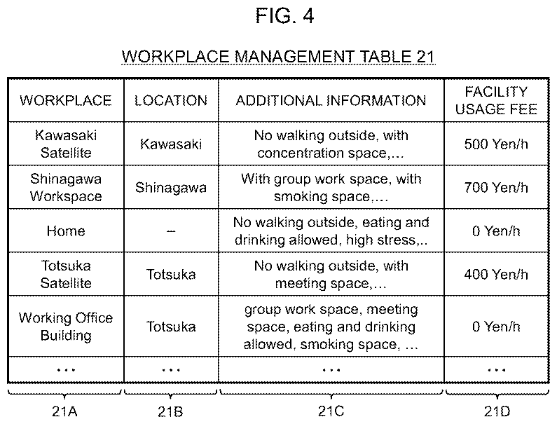

Moreover, the workplace management table 21 is a table used to manage, for example, respective facilities which are available as workplaces to each user registered in the labor support apparatus 5 in advance; and is configured by including, as illustrated in FIG. 4, a workplace column 21A, a location column 21B, an additional information column 21C, and a facility usage fee column 21D. In the workplace management table 21, one record (one row in FIG. 4) corresponds to one facility or the like (workplace) available to the user.

Then, the workplace column 21A stores the name of the relevant facility or the like (workplace); and the location column 21B stores a station name of a nearest station of the facility or the like. Moreover, the additional information column 21C stores information regarding the environment of the relevant facility or the like (whether various kinds of spaces exist or not, whether eating and drinking is allowed or not, and so on); and the facility usage fee column 21D stores a usage fee of the facility or the like.

Therefore, in a case of an example in FIG. 4, the user can use facilities or the like such as “Kawasaki Satellite,” “Shinagawa Workspace,” “Totsuka Satellite,” and so on other than the “Working Office Building” and “Home”; and it is indicated, for example, regarding “Shinagawa Workspace” among these facilities that “Shinagawa” Station is the nearest station and this facility has a “group work space,” a “smoking space,” and so on, and a facility usage fee of “700 yen/h” is required.

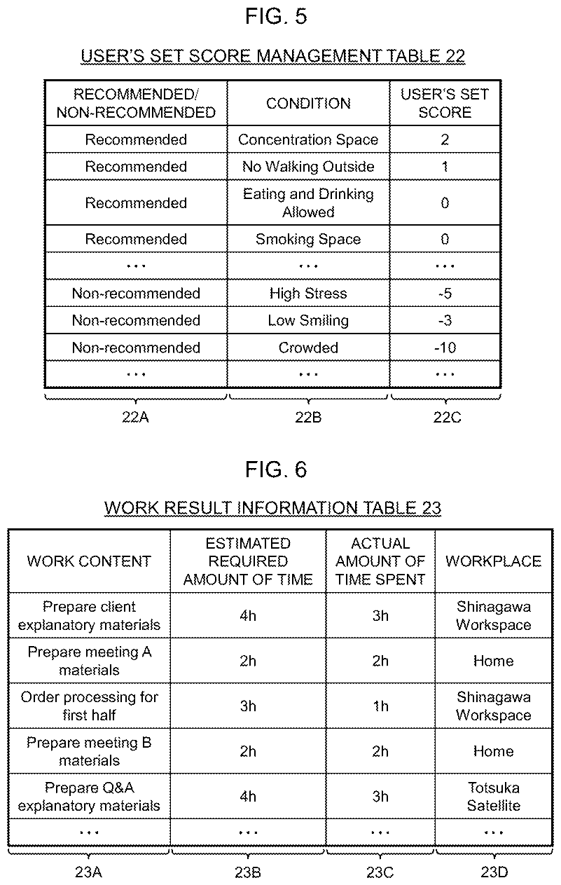

The user's set score management table 22 is: a table designed to manage an importance degree of conditions previously set by the user with respect to various kinds of conditions under which the labor support apparatus 5 selects the optimum workplace for the user; and is created for each user. This user's set score management table 22 is configured by including, as illustrated in FIG. 5, a recommended/non-recommended column 22A, a condition column 22B, and a user's set score column 22C. In the user's set score management table 22, one record (one row in FIG. 5) corresponds to one condition.

Then, the condition column 22B stores some preset conditions specifying that, for example, there is a concentration space (“Concentration Space”), the user can access the workplace without walking outside (“No Walking Outside”), eating and drinking is allowed at the workplace (“Eating and Drinking Allowed”), there is a smoking space (“Smoking Space”), the workplace causes high stress (“High Stress”), the workplace causes the user to smile less (“Low Smiling”), and the workplace is crowded (“Crowded”).

Moreover, the recommended/non-recommended column 22A stores information indicating whether the relevant condition is a condition of recommendation or a condition of non-recommendation (in FIG. 5, “Recommended” is stored when it is a condition of recommendation; and “Non-recommended” is stored when it is a condition of non-recommendation). Incidentally, whether the relevant condition is either a condition of recommendation condition (recommendation condition) or a condition of non-recommendation condition (non-recommendation condition) may be set in advance or may be set by the user.

Furthermore, the user's set score column 22C sets an importance degree of the relevant condition, which is set to the user's set score management table 22 by the relevant user (hereinafter referred to as the “user's set score”). The user's set score is set so that a positive value is set to the recommendation condition and a negative value is set to the non-recommendation condition.

Therefore, in a case of an example in FIG. 5, it is shown that as the user's set score for various kinds of conditions under which the labor support apparatus 5 selects the optimum workplace for a certain user, “2” is set for the “Concentration Space,” “1” is set for “No Walking Outside,” and “0” is set for “Eating and Drinking Allowed,” respectively. Moreover, FIG. 5 shows that the user's set score is set as “−5,” “−3,” and “−10” regarding the conditions of “High Stress,” “Low Smiling,” and “Crowded,” respectively.

The work result information table 23: is a table used to manage actual results of the required amount of time for the user to perform various kinds of work and workplaces used then; and is created for each user. This work result information table 23 is configured by including, as illustrated in FIG. 6, a work content column 23A, an estimated amount-of-required-time column 23B, an actual amount-of-time spent column 23C, and a workplace column 23D. In the work result information table 23, one record (one row in FIG. 6) corresponds to an actual result (work result) of one piece of work which the relevant user performed in the past.

Then, the work content column 23A stores the content of work performed by the relevant user with respect to the relevant work result; and the estimated amount-of-required-time column 23B stores a required amount of time estimated by the user for that work (estimated amount of required time). Incidentally, the estimated amount of required time may be the time which is scheduled by the relevant user for a schedule such as a TO DO list and is acquired by the labor support apparatus 5 from the company use server 3, or may be the time previously set by a person such as a project leader other than the user.

Moreover, the actual amount-of-time spent column 23C and the workplace column 23D store an amount of time actually spent by the user (actual time spent) for the work, which is acquired by the labor support apparatus 5 from, for example, a daily work report registered by the user with the company use server 3, and the location where the user performed the relevant work.

Therefore, in a case of an example in FIG. 6, it is shown that the relevant user estimated the required time of “4 h” for the work performed in the past to “prepare client explanatory materials,” but the user was able to finish the work for “3 h” at “Shinagawa Workspace.”

The stress-degree-and-smiling-degree information table 24: is a table used to store and manage the user's stress degree and smiling degree which were acquired when the user worked at each workplace in the past; and is created for each user. Incidentally, the term “stress degree” herein used indicates the users degree of stress which was measured when the relevant user worked at the relevant workplace; and the term “smiling degree” indicates to what degree the user smiled then. The details of the stress degree and the smiling degree will be described later in detail.

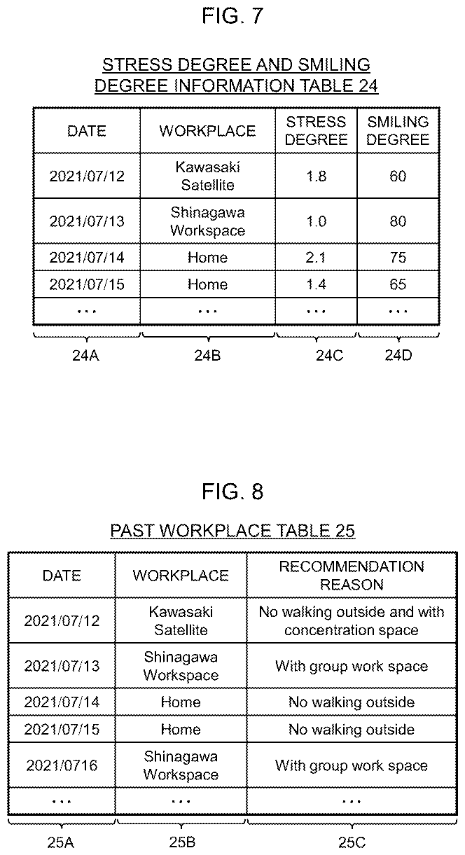

This stress-degree-and-smiling-degree information table 24 is configured by including, as illustrated in FIG. 7, a date column 24A, a workplace column 24B, a stress degree column 24C, and a smiling degree column 24D. In the stress-degree-and-smiling-degree information table 24, one record (one row in FIG. 7) corresponds to the relevant users one set of working at the relevant workplace.

Then, the date column 24A stores the date when the stress degree and the smiling degree were measured regarding the relevant user; and the workplace column 24B stores the workplace where the user worked then. Moreover, the stress degree column 24C and the smiling degree column 24D store the user's the stress degree and smiling degree which were then measured, respectively.

Therefore, in a case of an example in FIG. 7, it is shown that when the relevant user worked at “Kawasaki Satellite” on “2021/07/12,” the user's stress degree was “1.8” and their smiling degree was “60.”

The past workplace information table 25 is a table used to manage a workplace selected by the user from some workplaces proposed (recommended) by the labor support apparatus 5 to the user as the optimum workplace(s) in the past, and the reason why the labor support apparatus 5 recommended that workplace then; and is created for each user. This past workplace information table 25 is configured by including, as illustrated in FIG. 8, a date column 25A, a workplace column 25B, and a recommendation reason column 25C. In the past workplace information table 25, one record (one row in FIG. 8) corresponds to one workplace selected by the user from some workplaces proposed by the labor support apparatus 5.

Then, the date column 25A stores the date when the workplace desired by the user was selected from some workplaces proposed by the labor support apparatus 5; and the workplace column 25B stores the name of that workplace. Moreover, the recommendation reason column 25C stores the reason why the labor support apparatus 5 recommended that workplace (recommendation reason) at that time. Therefore, in a case of an example in FIG. 8, it is shown that the labor support apparatus 5 proposed “Kawasaki Satellite” as a workplace to the relevant user on “2021/07/12” and the recommendation reason was “No Walking Outside” and “with Concentration Space.”

Incidentally, the weather-condition-based score management table 26 and the service-status-based score management table 27 will be described later in detail.

Meanwhile, the user information management program 28 is a program having a function that registers and manages various kinds of information regarding each previously registered user in the user management table 20 and the user's set score management table 22 and stores and manages various kinds of information, which was acquired by the user when they used the labor support services in the past, in the work result information table 23, the stress-degree-and-smiling-degree information table 24, or the past workplace information table 25.

Moreover, the workplace information management program 29 is a program having a function that registers and manages various kinds of previously given information regarding workplaces, which are available to each user, in the workplace management table 21.

The workplace-and-working-hours-proposing program 30 is a program having a function that selects some workplace candidates which are optimum for the user (hereinafter referred to as the “workplace candidates”) and working hours on the basis of, for example, various kinds of information registered in the respective tables mentioned above such as the user management table 20 and the workplace management table 21, the today's weather information acquired from various kinds of external service servers 4, the service status and the crowdedness information of the necessary public transportation, various kinds of information acquired from the company use server 3 of the company or the like for which the user works.

Furthermore, the chatbot program 31 is a program having a function that generates a message when proposing the workplace candidates and the working hours, which are selected by the workplace-and-working-hours-proposing program 30, to the user.

Furthermore, the chat program 32 is a program having a function that sends a message generated by the chatbot program 31 to the user terminal 2 and delivers a message from the user terminal 2 to the chatbot program 31. Moreover, the chat program 32 stores and manages these messages.

### (3) Workplace-and-Working-Hours-Proposing Screen

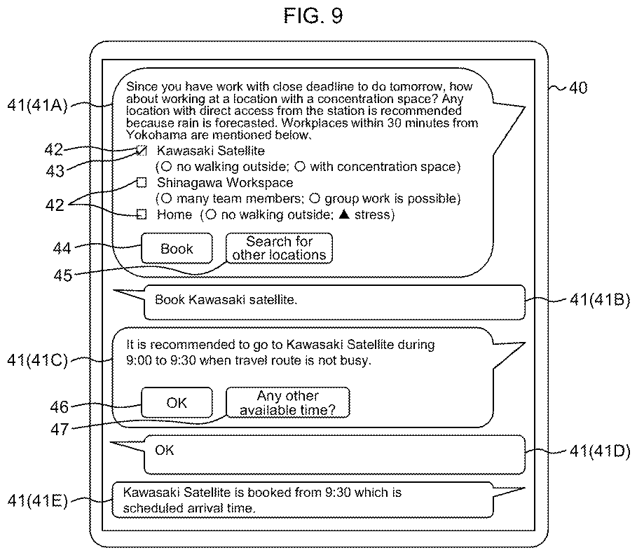

FIG. 9 illustrates a configuration example of a workplace-and-working-hours-proposing screen 40 which is displayed on the user terminal 2 of the user who uses the labor support services provided by the labor support apparatus 5.

On this workplace-and-working-hours-proposing screen 40, messages of the labor support apparatus 5 and messages according to the user's operations are respectively described in speech bubbles 41 and the respective speech bubbles 41 are displayed, in a chat format, sequentially downwards in the sequential order of the messages.

Then, on the workplace-and-working-hours-proposing screen 40, firstly the names of some workplace candidates selected by the workplace-and-working-hours-proposing program 30, and a recommendation reason(s) for each of these workplace candidates (the reason(s) stated after the sign o in FIG. 9) or a non-recommendation reason(s) (the reason(s) stated after the sign ▴ in FIG. 9) are displayed within a first speech bubble 41A.

For example, FIG. 9 shows an example where “Kawasaki Satellite,” “Shinagawa Workspace,” and “Home” are presented as workplace candidates; and regarding these candidates, the recommendation reasons for “Kawasaki Satellite” among these candidates are “No Walking Outside” and “with Concentration Space” and the recommendation reason for “Home” is “No Walking Outside” and its non-recommendation reason is “High Stress.”

Moreover, check boxes 42 are displayed respectively corresponding to the respective workplace candidates in the first speech bubble 41A. Then, a target user clicks a check box 42 corresponding to a desired workplace candidate among these check boxes 42, so that it becomes possible to select the workplace candidate associated with that check box 42 as the desired workplace. A check mark 43 is displayed in the check box 42 which is then clicked.

Furthermore, a booking button 44 and another place proposal request button 45 are displayed within the first speech bubble 41A; and by clicking the booking button 44 after selecting the desired workplace candidate as described above, it is possible to issues an instruction to the labor support apparatus 5 that the workplace candidate should be booked.

In this case, a new second speech bubble 41B for displaying the user's message is displayed below the first speech bubble 41A and a message stating something like “Book ΔΔ” is displayed within second speech bubble 41B. Incidentally, the sign “ΔΔ” represents the name of the workplace candidate selected by the user.

Also, when there is no desired workplace among the workplace candidates displayed in the first speech bubble 41A, the user dicks another place proposal request button 45, so that it becomes possible to switch the respective workplace candidates displayed within the first speech bubble 41A to other workplace candidates, each of which has not been displayed yet.

Meanwhile, on the workplace-and-working-hours-proposing screen 40, a third speech bubble 41C for displaying a message from the labor support apparatus 5 is displayed below the second speech bubble 41B after the second speech bubble 41B is displayed as described above. Then, recommended working hours (“9:00-9:30” in an example in FIG. 9) as working hours for a target workplace candidate then designated by the user, an OK button 46, and another time proposal request button 47 are displayed within this third speech bubble 41C.

Then, by clicking the OK button 46, the user can inform the labor support apparatus 5 that the user accepts the working hours displayed within the third speech bubble 41C. In this case, a new fourth speech bubble 41D for displaying the user's message is displayed below the third speech bubble 41C and the message stating “OK” is displayed within the fourth speech bubble 41D.

Moreover, if the user wants time other than the working hours displayed within the third speech bubble 41C, the user can switch the working hours displayed within the third speech bubble 41C to other working hours by clicking another time proposal request button 47.

Meanwhile, on the workplace-and-working-hours-proposing screen 40, when the fourth speech bubble 41D is displayed as described above and then the labor support apparatus 5 finishes booking the workplace designated by the user in the first speech bubble 41A for a time slot according to the working hours displayed within the third speech bubble 41C, a fifth speech bubble 41E for displaying a message from the labor support apparatus 5 is displayed below the fourth speech bubble 41D.

Then, a message stating “ΔΔ is booked from oo:oo which is scheduled arrival time” to report in the fifth speech bubble 41E that the workplace candidate designated by the user in this first speech bubble 41A is booked as a workplace is displayed. Incidentally, the sign “ΔΔ” represents the name of the workplace selected by the user within the first speech bubble 41A and “oo:oo” represents the scheduled arrival time to the nearest station of the workplace during the working hours accepted by the user.

(4) Various Kinds of Processing Regarding Labor Support Service Function According to this Embodiment

Next, an explanation will be provided about specific processing content of various kinds of processing executed at the labor support apparatus regarding the labor support service function according to this embodiment. Incidentally, in the following explanation, a processing subject of the various kinds of processing will be explained as a “program”; however, it is needless to say that practically the CPU 9 (FIG. 1) for the labor support apparatus 5 executes the processing according to the “program.”

(4-1) Labor Support Service Provision Processing

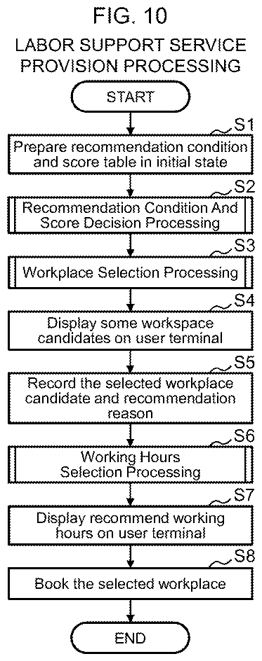

FIG. 10 illustrates a flow of a processing sequence started in the labor support apparatus 5 at the timing when the user starts using the labor support services (hereinafter referred to as the “labor support service provision processing”).

As illustrated in FIG. 10, when the user (hereinafter referred to as the “target user”) starts using the labor support services provided by the labor support apparatus 5 by performing a specified operation of their own user terminal 2, the workplace-and-working-hours-proposing program 30 (FIG. 2) for the labor support apparatus 5 firstly creates a recommendation-condition-and-score table 50 in an initial state as illustrated in FIG. 11 on the basis of the user's set score management table 22 (FIG. 5) (S1).

This recommendation-condition-and-score table 50 is a table used, when the labor support apparatus 5 selects the today's optimum workplace(s) for the target user, to adjust a value of the user's set score, which was previously set by the target user to each condition, and add a new condition on the basis of the target users environment and schedule and the target user's work status in the past.

Incidentally, the expression “target user's environment” herein used indicates the today's weather condition, the current service status of the public transportation, and a budget and KPI (a desired attendance rate in this example) of an organization to which the target user belongs. Also, the “target user's schedule” includes a schedule of work which the target user should execute alone (individual work) and a schedule of work which the target user should execute jointly with members of a team to which the target user belongs (team work). Furthermore, the “target users work status in the past” indicates workplaces selected by the target user in the past, work efficiency when the target user worked at each workplace in the past, and the stress degree and the smiling degree when the target user worked at each workplace in the past.

This recommendation-condition-and-score table 50 is configured by including, as illustrated in FIG. 11, a recommended/non-recommended column 50A, a condition column 50B, a recommendation score column 50C, and a user's set score column 500. In the recommendation-condition-and-score table 50, one record (one row in FIG. 11) corresponds to one condition under which the labor support apparatus 5 selects the optimum workplace for the target user.

Then, the recommended/non-recommended column 50A, the condition column 50B, and the user's set score column 50D store the same information as that of the recommended/non-recommended column 22A, the condition column 22B, and the user's set score column 22C of the user's set score management table 22, respectively. Moreover, the recommendation score column 50C in the initial state stores the same value as that of the user's set score stored in the same record of the user's set score column 50D.

Subsequently, the workplace-and-working-hours-proposing program 30 executes recommendation-condition-and-score decision processing for adjusting the user's set score for each condition, which was previously set by the target user, and adding a new condition on the basis of the target user's environment and schedule and the target user's work status in the past as described earlier (S2).

Next, the workplace-and-working-hours-proposing program 30 executes workplace selection processing for evaluating each workplace which is available to the target user on the basis of the recommendation score for each condition decided by the recommendation-condition-and-score decision processing and selecting some optimum workplaces for the target user as workplace candidates (S3).

Then, the chatbot program 31 (FIG. 2) generates a message including the workplace candidates selected by the workplace-and-working-hours-proposing program 30 and their recommendation reasons and the chat program 32 (FIG. 2) sends this message to the target user's user terminal 2. Consequently, the first speech bubble 41A (FIG. 9), in which some workplace candidates selected by the workplace-and-working-hours-proposing program 30 are placed, is displayed on the workplace-and-working-hours-proposing screen 40 (FIG. 9) displayed on the user terminal 2 (S4).

Subsequently, when the target user selects one desired workplace candidate from some workplace candidates displayed on the user terminal 2, the labor support apparatus 5 is notified by the user terminal 2 of that workplace candidate. Then, the user information management program 28 (FIG. 2) for the labor support apparatus 5 which has received this notice registers the then-selected workplace candidate (hereinafter referred to as the “user-selected workplace candidate”) and the reason why the workplace-and-working-hours-proposing program 30 recommended the user-selected workplace candidate (recommendation reason) in the past workplace information table 25 (FIG. 8) (S5).

Subsequently, the workplace-and-working-hours-proposing program 30 executes working hours selection processing for selecting recommend working hours (for example, time to avoid a crowded state while traveling) on the basis of the current service status and crowdedness status of the public transportation which the target user uses to travel from home to the user-selected workplace candidate (S6).

Next, the chatbot program 31 generates a message to propose the working hours selected by the workplace-and-working-hours-proposing program 30 and the chat program 32 sends this message to the target user's user terminal 2. Consequently, the third speech bubble 41C (FIG. 9), in which the working hours selected by the workplace-and-working-hours-proposing program 30 are placed, is displayed in the workplace-and-working-hours-proposing screen 40 displayed on the user terminal 2 (S7).

Subsequently, when the target user performs an operation to accept the working hours displayed on the user terminal 2, the labor support apparatus 5 is notified by the user terminal 2 to that effect. Then, the workplace-and-working-hours-proposing program 30 for the labor support apparatus 5 which has received this notice accesses a booking site of the user-selected workplace candidate and books the user-selected workplace candidate from the time according to the then-accepted working hours (S8). As a result, this sequence of the labor support service provision processing is terminated.

(4-1-1) Recommendation-Condition-and-Score Decision Processing

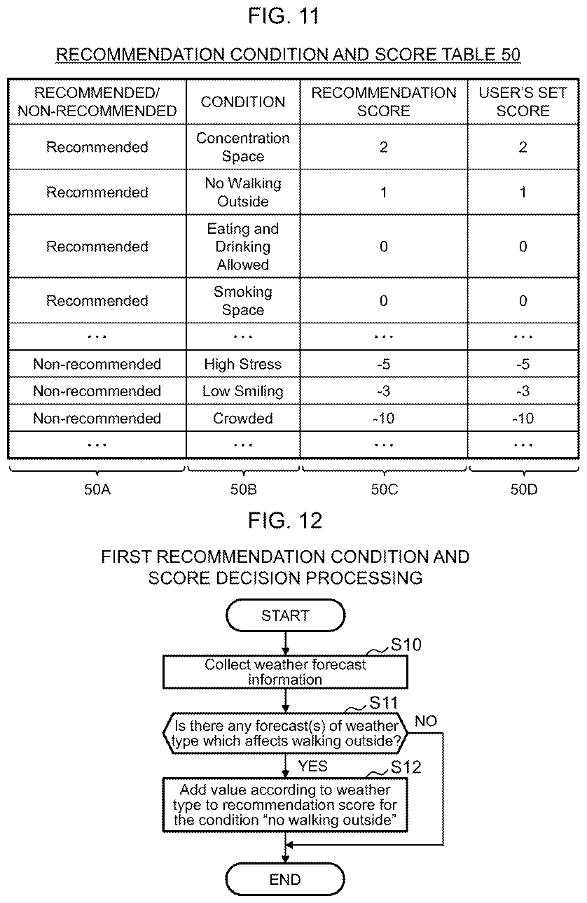

Now, an explanation will be provided about specific processing content of the recommendation-condition-and-score decision processing executed in step S2 of the aforementioned labor support service provision processing (FIG. 10). This recommendation-condition-and-score decision processing is executed by the workplace-and-working-hours-proposing program 30 by executing first to eighth recommendation-condition-and-score decision processing described later with reference to FIG. 12 to FIG. 26 in their sequential order.

(4-1-1-1) First Recommendation-Condition-and-Score Decision Processing

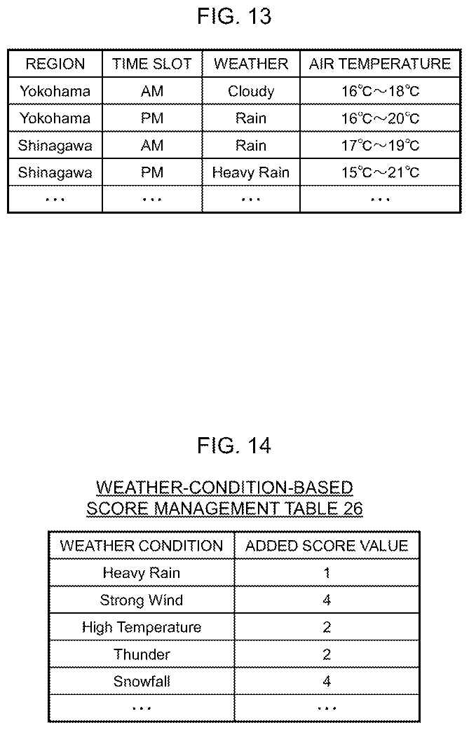

When the workplace-and-working-hours-proposing program 30 proceeds to step S2 of the labor support service provision processing, it firstly starts the first recommendation-condition-and-score decision processing illustrated in FIG. 12 and firstly accesses the external service server 4 (FIG. 1) used by the Meteorological Agency or a private weather forecast company and, as illustrated in FIG. 13, collects weather forecast information regarding the today's weather and air temperature around each workplace which is available to the target user (S10).

Subsequently, the workplace-and-working-hours-proposing program 30 judges whether any forecast of weather conditions which may affect walking outside, such as a heavy rain, a strong wind, a high temperature, or a snowfall, has been published or not on the basis of the weather forecast information collected in step S10 (S11). Then, if the workplace-and-working-hours-proposing program 30 obtains a negative result in this judgment, it terminates this first recommendation-condition-and-score decision processing.

On the other hand, if the workplace-and-working-hours-proposing program 30 obtains an affirmative result in the judgment of step S11, it adds a value according to the weather condition which may affect walking outside as recognized in step S11 with respect to the recommendation score for the condition “No Walking Outside” in the recommendation-condition-and-score table 50 (FIG. 11) in the initial state which was created in step S1 of the labor support service provision processing described earlier with reference to FIG. 10 (S12).

As a means for achieving the above-described purpose, the workplace-and-working-hours-proposing program 30 manages the weather-condition-based score management table 26 which is illustrated in FIG. 14 and stored in the storage apparatus 11 (FIG. 2) in advance. This weather-condition-based score management table 26 is a table in which a weather condition which may affect walking outside is associated with the value to be added to the recommendation score which is previously set to the relevant weather condition (hereinafter referred to as the “added score value”).

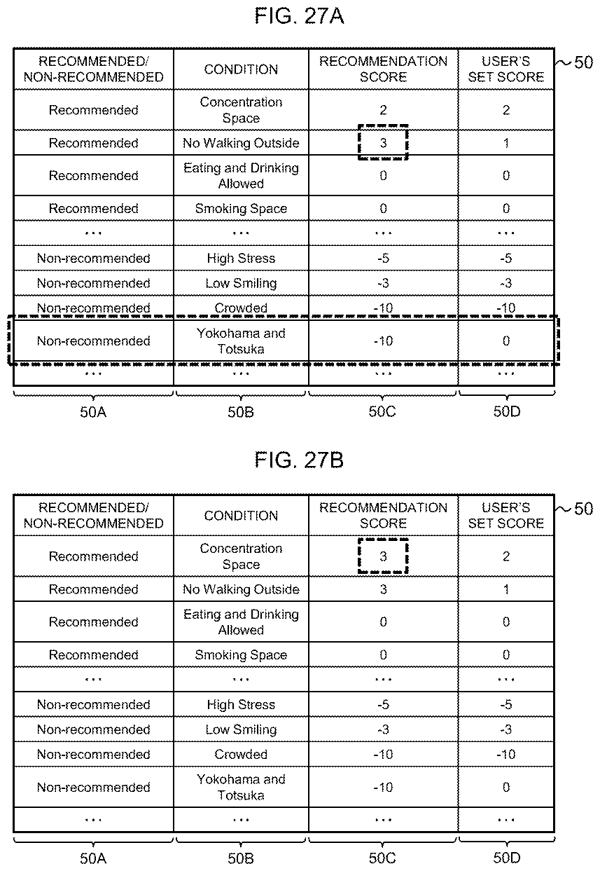

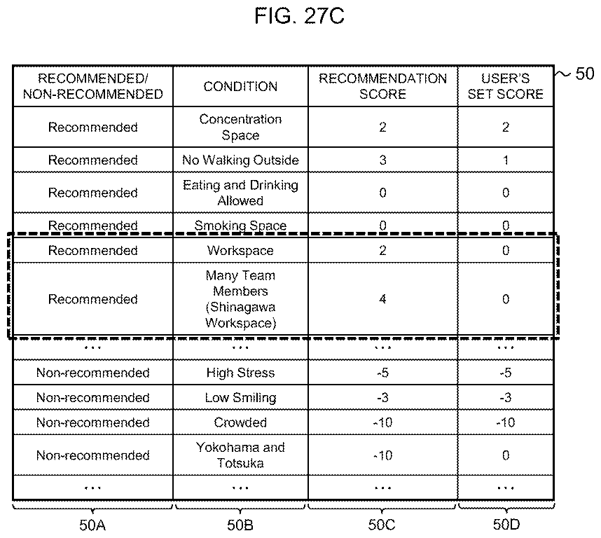

Then, the workplace-and-working-hours-proposing program 30 reads the added score value, which was associated in step S12 with the weather condition recognized in step S11, from the weather-condition-based score management table 26 and adds the read added score value to the recommendation score for the condition “No Walking Outside” in the recommendation-condition-and-score table 50 (FIG. 11) in the initial state as illustrated in FIG. 27A. Incidentally, FIG. 27A is an example of the case where since the weather condition in an example in FIG. 14 is a “High Temperature,” its added score value “2” is added to the recommendation score for the condition “No Walking Outside.” Then, the workplace-and-working-hours-proposing program 30 terminates this first recommendation-condition-and-score decision processing.

(4-1-1-2) Second Recommendation-Condition-and-Score Decision Processing

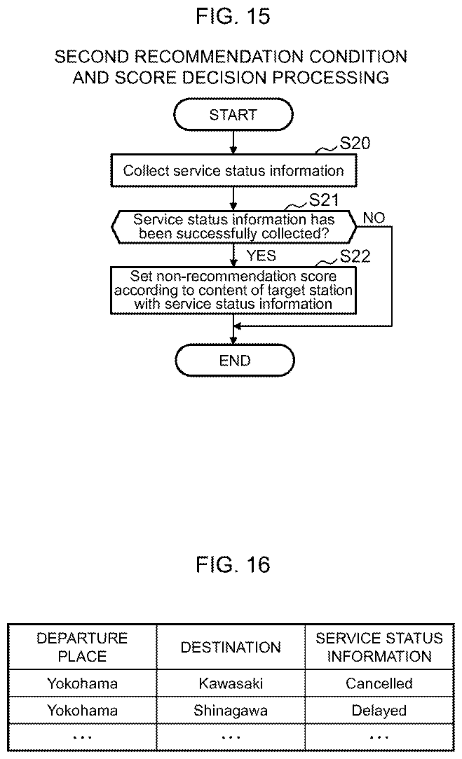

The workplace-and-working-hours-proposing program 30 then starts the second recommendation-condition-and-score decision processing illustrated in FIG. 15, firstly accesses the external service server 4 used by the required public transportation company, and collects service status information related to a section from the nearest station of the target user's home (“departure place”) to the nearest station of each workplace which is available to the target user (“destination”) (hereinafter referred to as the “target section”) as illustrated in FIG. 16 from among the service status information which is then published (S20). Incidentally, the service status information which is collected here is the service status information such as the services canceled, delayed, an accident(s), disrupted train services, and services temporarily suspended which may affect traveling in the target section by using the public transportation.

Subsequently, the workplace-and-working-hours-proposing program 30 judges whether the service status information related to each target section has been successfully collected or not in step S20 (S21). Then, if the workplace-and-working-hours-proposing program 30 obtains a negative result in this judgment, it terminates this second recommendation-condition-and-score decision processing.

On the other hand, if the workplace-and-working-hours-proposing program 30 obtains an affirmative result in the judgment of step S21, it adds the nearest station of each workplace related to the service status information recognized in step S21 and the nearest station of the target user's home as non-recommendation conditions to the recommendation-condition-and-score table 50 (a record with the value “Yokohama and Totsuka” in the condition column 50B) and sets a value according to the service status information recognized in step S21 as a recommendation score for that non-recommendation condition as illustrated in FIG. 27A (S22).

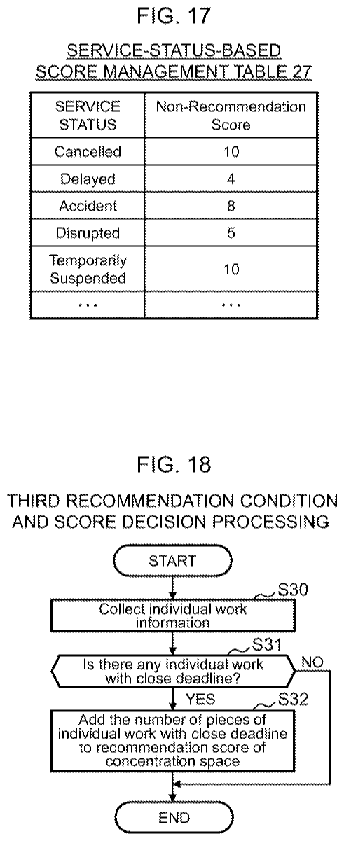

As a means for achieving the above-mentioned purpose, the workplace-and-working-hours-proposing program 30 manages the service-status-based score management table 27 which is illustrated in FIG. 17 and is stored in the storage apparatus 11 (FIG. 2) in advance. This service-status-based score management table 27 is a table in which the service status which may affect travelling by using the relevant public transportation is associated with the value of the non-recommendation score which should be set to the previously defined service status.

Then, the workplace-and-working-hours-proposing program 30 reads the non-recommendation score, which was associated in step S22 with the service status recognized in step S21, from the service-status-based score management table 27 and sets the read non-recommendation score to a recommendation score for the non-recommendation condition added to the recommendation-condition-and-score table 50 as illustrated in FIG. 27A. Incidentally, the non-recommendation score is set as the recommendation score, which has the same absolute value, but is a negative value, to the recommendation-condition-and-score table 50. Then, the workplace-and-working-hours-proposing program 30 terminates this second recommendation-condition-and-score decision processing.

(4-1-1-3) Third Recommendation-Condition-and-Score Decision Processing

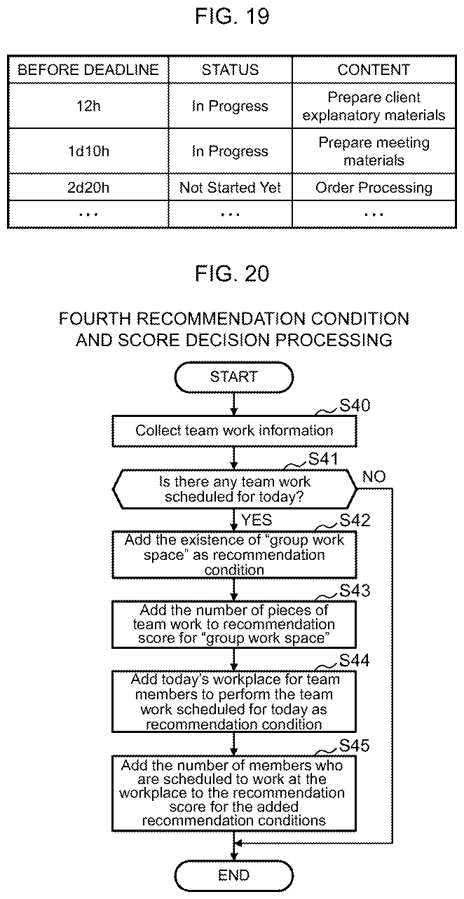

Subsequently, the workplace-and-working-hours-proposing program 30 starts the third recommendation-condition-and-score decision processing illustrated in FIG. 18, firstly accesses the company use server 3 (FIG. 1) of the company or the like for which the target user works, and collects information of all pieces of individual work which are registered in a schedule such as a TO DO list by the target user and should be conducted by the target user (hereinafter referred to as the “individual work information”) as illustrated in FIG. 19 (S30).

Then, the workplace-and-working-hours-proposing program 30 judges, based on the collected individual work information, whether or not there is any individual work with a deadline approaching within a certain period of time (for example, within 24 hours) (S31). Then, if the workplace-and-working-hours-proposing program 30 obtains a negative result in this judgment, it terminates this third recommendation-condition-and-score decision processing.

On the other hand, if the workplace-and-working-hours-proposing program 30 obtains an affirmative result in the judgment of step S31, it adds the same number as the number of pieces of the individual work with the deadline approaching within the certain period of time to the recommendation score for the condition “Concentration Space” in the recommendation-condition-and-score table 50 (FIG. 11) as illustrated in FIG. 27B (S32). Incidentally, FIG. 27B shows an example where since the number of pieces of the individual work with the deadline approaching within the certain period of time is one, “1” is added to the recommendation score for the condition “Concentration Space.”

Then, the workplace-and-working-hours-proposing program 30 terminates this third recommendation-condition-and-score decision processing.

(4-1-1-4) Fourth Recommendation-Condition-and-Score Decision Processing

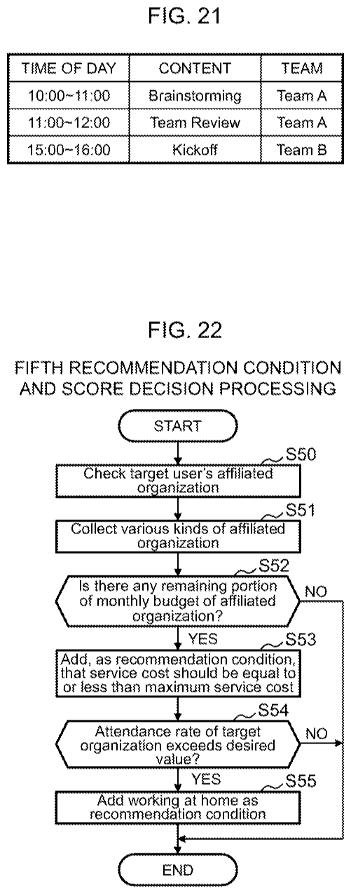

The workplace-and-working-hours-proposing program 30 then starts the fourth recommendation-condition-and-score decision processing illustrated in FIG. 20, firstly accesses the company use server 3 (FIG. 1) of the company or the like for which the target user works, and collects information of all pieces of team work which are registered in the schedule such as the TO DO list by the target user and should be conducted by the target user (hereinafter referred to as the “team work information”) as illustrated in FIG. 21 (S40).

Subsequently, the workplace-and-working-hours-proposing program 30 judges, based on the collected team work information, whether or not there is any team work which is scheduled for today (S41). Then, if the workplace-and-working-hours-proposing program 30 obtains a negative result in this judgment, it terminates this fourth recommendation-condition-and-score decision processing.

On the other hand, if the workplace-and-working-hours-proposing program 30 obtains an affirmative result in the judgment of step S41 and if the existence of a group work space (“Group Work Space”) is not registered as a condition in the recommendation-condition-and-score table 50 as illustrated in FIG. 27C, it adds that condition as a recommendation condition to the recommendation-condition-and-score table (S42). When doing so, the workplace-and-working-hours-proposing program 30 sets “0” as a value of the user's set score for that recommendation condition (“Group Work Space”).

Also, the workplace-and-working-hours-proposing program 30 adds the same number as the number of pieces of the team work scheduled for today to the recommendation score for the recommendation condition added in step S42 (“Group Work Space”) (S43). Incidentally, FIG. 27C shows an example where since the number of pieces of the team work scheduled for today is two, “2” is added to the recommendation score for the condition “Group Work Space.”

Subsequently, the workplace-and-working-hours-proposing program 30 acquires each today's workplace scheduled by each of other members who belong to the team for conducting the relevant team work, with respect to each piece of team work scheduled for today, from the company use server 3 (FIG. 1) and adds all the acquired workplaces, respectively as new recommendation conditions, to the recommendation-condition-and-score table 50 (a record whose value of the condition column 50B is “Many Team Members (Shinagawa Workspace)”) as illustrated in FIG. 27C (S44). When doing so, the workplace-and-working-hours-proposing program 30 sets “0” to all the values of the user's set scores for these recommendation conditions.

Next, the workplace-and-working-hours-proposing program 30 adds the same number as the number of the members, other than the target user, who belong to the team to which the target user belongs, and who are scheduled to work today at the workplace corresponding to the relevant recommendation condition, to the recommendation score for the relevant recommendation condition, with respect to each recommendation condition added in step S44 (S45). Incidentally, FIG. 27C shows an example where the number of the members who belongs to the team and are scheduled to work today at “Shinagawa Workspace” is four, “4” is added to the recommendation score for the condition “Many Team Members (Shinagawa Workspace).”

Then, the workplace-and-working-hours-proposing program 30 terminates this fourth recommendation-condition-and-score decision processing.

(4-1-1-5) Fifth Recommendation-Condition-and-Score Decision Processing

The workplace-and-working-hours-proposing program 30 then starts the fifth recommendation-condition-and-score decision processing illustrated in FIG. 22, firstly refers to the user management information table 20 (FIG. 3) of the target user, and checks an organization to which the target user belongs (hereinafter referred to as the “affiliated organization”) (S50).

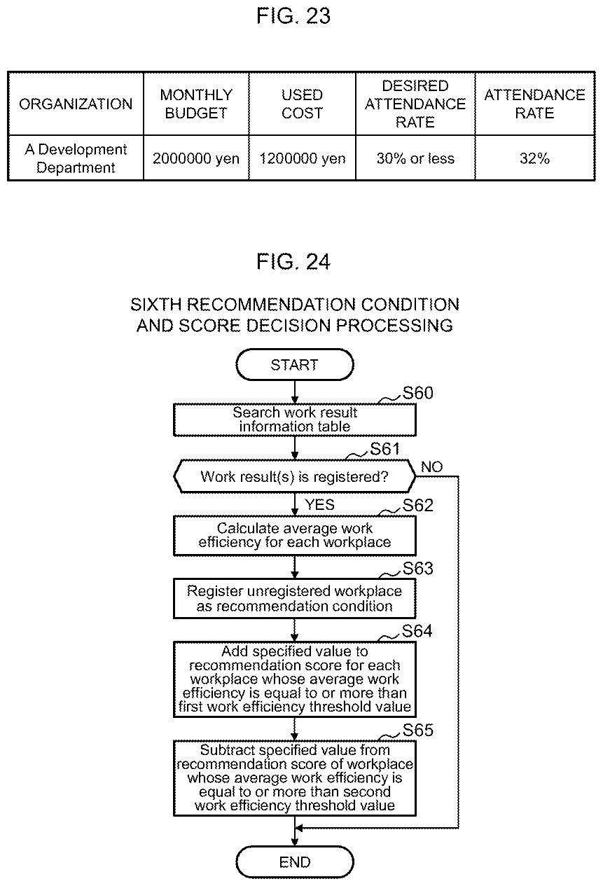

Subsequently, the workplace-and-working-hours-proposing program 30 accesses the company use server 3 (FIG. 1) of the company or the like for which the target user works, and collects information regarding the budget of the affiliated organization (a monthly budget and a used cost), information regarding attendance rates at the affiliated organization (a desired attendance rate and an actual attendance rate at present point in time), and information regarding the structure of the affiliated organization (the number of constituent members) as illustrated in FIG. 23 (S51).

Next, the workplace-and-working-hours-proposing program 30 judges, based on each piece of information collected in step S51, whether or not there is any remaining portion of the monthly budget of the affiliated organization (whether the used cost is less than the monthly budget or not) (S52). Then, if the workplace-and-working-hours-proposing program 30 obtains a negative result in this judgment, it terminates this fifth recommendation-condition-and-score decision processing.

On the other hand, if the workplace-and-working-hours-proposing program 30 obtains an affirmative result in the judgment of step S52, it adds an amount of money available to each member per day, when the remaining monthly budget of the affiliated organization is equally allocated to the members, as a maximum service cost, and a new recommendation condition specifying that a service cost per day for one member of the affiliated organization should be equal to or less than the maximum service cost, to the recommendation-condition-and-score table 50 (S53).

Specifically speaking, the workplace-and-working-hours-proposing program 30 sets that the service cost per day for one member of the affiliated organization becomes equal to or less than the maximum service cost which is calculated according to the expression indicated below, and adds it as a new recommendation condition to the recommendation-condition-and-score table 50.

[Math. 1]

Maximum Service Cost=A/B (1)

A: Monthly Budget—Used Cost for This Month

B: The Number of Remaining Days of Attendance for This Month×The Number of Members Belonging to Organization

Incidentally, the term “service cost” herein used means a total amount of a necessary transportation cost for the user to travel from home to the workplace and from the workplace to home and a facility usage fee required to use that workplace. The transportation cost from the user's home to each workplace can be acquired from the user's user management table 20 (FIG. 3) and the facility usage fee per unit time when the user works at each workplace can be acquired from the workplace management table 21 (FIG. 4). Moreover, the remaining days of attendance means a total number of days on which the members can go to work this month, which is calculated from a desired attendance rate of the organization and its actual attendance rate at the present point in time, and the number of constituent members of the organization.

Subsequently, the workplace-and-working-hours-proposing program 30 judges, based on the information collected in step S51, whether or not the actual attendance rate of the organization at the present point in time exceeds the desired attendance rate of the affiliated organization (S54). Then, if the workplace-and-working-hours-proposing program 30 obtains a negative result in this judgment, it terminates this fifth recommendation-condition-and-score decision processing.

On the other hand, if the workplace-and-working-hours-proposing program 30 obtains an affirmative result in the judgment of step S54, it adds working at home by using their home as a workplace as a recommendation condition to the recommendation-condition-and-score table 50 and sets a specified value as a recommendation score for that recommendation condition (for example, “1”) (S55). Then, the workplace-and-working-hours-proposing program 30 terminates this fifth recommendation-condition-and-score decision processing.

(4-1-1-6) Sixth Recommendation-Condition-and-Score Decision Processing

When the workplace-and-working-hours-proposing program 30 terminates the fifth recommendation-condition-and-score decision processing, it starts the sixth recommendation-condition-and-score decision processing illustrated in FIG. 24 and firstly searches the work result information table 23 (FIG. 6) of each user for the target user's work result information table 23 (FIG. 6) (S60).

Then, the workplace-and-working-hours-proposing program 30 judges whether or not there is one or more records in the work result information table 23 of the target user which is detected by the search (S61). Then, if the workplace-and-working-hours-proposing program 30 obtains a negative result in this judgment, it terminates this sixth recommendation-condition-and-score decision processing.

On the other hand, if the workplace-and-working-hours-proposing program 30 obtains an affirmative result in the judgment of step S61, it calculates average work efficiency at each workplace with work results on the basis of the information of each work result registered in the work result information table 23 of the target user according to the following expression (S62).

$$\begin{matrix}[ Math . 2 ] & \\ Average Work Efficiency = \frac{\begin{matrix}Total Estimated Amount of \\ Required Time at the Relevant Workplace\end{matrix}}{\begin{matrix}Total Actual Amount of \\ Time Spent at the Relevant Workplace\end{matrix}} & ( 2 )\end{matrix}$$

Subsequently, if a workplace with the work result is not registered in the recommendation-condition-and-score table 50, the workplace-and-working-hours-proposing program 30 sets working at that workplace as a new recommendation condition and adds “o” as the recommendation score to the recommendation-condition-and-score table 50 (S63).

Next, the workplace-and-working-hours-proposing program 30 adds a specified value (for example, “1”) to the recommendation score for each workplace regarding which the average work efficiency calculated in step S62 in the recommendation-condition-and-score table 50 is equal to or larger than a preset first work efficiency threshold value (for example, 1.2) (S64).

Moreover, the workplace-and-working-hours-proposing program 30 subtracts a specified value (for example, “1”) from the recommendation score of each workplace regarding which the average work efficiency calculated in step S62 in the recommendation-condition-and-score table 50 is equal to or smaller than a preset second work efficiency threshold value (for example, 0.8) (S65). Then, the workplace-and-working-hours-proposing program 30 terminates this sixth recommendation-condition-and-score decision processing.

(4-1-1-7) Seventh Recommendation-Condition-and-Score Decision Processing

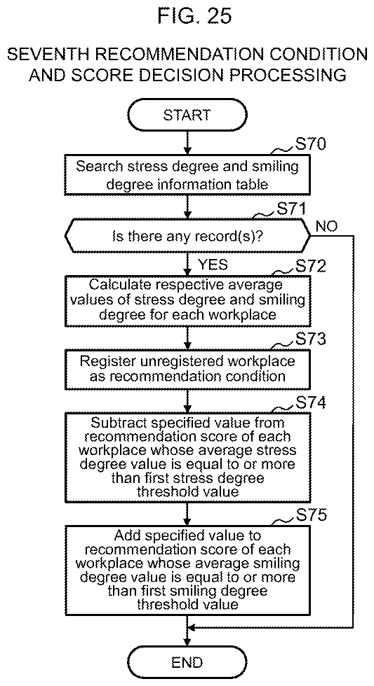

The workplace-and-working-hours-proposing program 30 then starts the seventh recommendation-condition-and-score decision processing illustrated in FIG. 25 and firstly searches the stress-degree-and-smiling-degree information table 24 (FIG. 7) of each user for the stress-degree-and-smiling-degree information table 24 of the target user (S70).

Then, the workplace-and-working-hours-proposing program 30 judges whether or not there is one or more records in the stress-degree-and-smiling-degree information table 24 which is detected by the search (871). Then, if the workplace-and-working-hours-proposing program 30 obtains a negative result in this judgment, it terminates this seventh recommendation-condition-and-score decision processing.

On the other hand, if the workplace-and-working-hours-proposing program 30 obtains an affirmative result in the judgment of step S71, it calculates respective average values of the stress degree and the smiling degree at each workplace for which the stress degree and the smiling degree are acquired, on the basis of the stress degree and the smiling degree at each workplace registered in the target user's stress-degree-and-smiling-degree information table 24 (S72).

Subsequently, if a workplace with the work result is not registered in the recommendation-condition-and-score table 50, the workplace-and-working-hours-proposing program 30 sets working at that workplace as a new recommendation condition and adds “0” as the recommendation score to the recommendation-condition-and-score table 50 (S73).

Next, the workplace-and-working-hours-proposing program 30 subtracts a specified value (for example, “1”) from the recommendation store of each workplace regarding which the average value of the stress degree calculated in step S72 in the recommendation-condition-and-score table 50 is equal to or larger than a preset first stress degree threshold value (for example, 1.5) (S74).

Moreover, the workplace-and-working-hours-proposing program 30 adds a specified value (for example, “1”) to the recommendation score of each workplace regarding which the average value of the smiling degree calculated in step S72 in the recommendation-condition-and-score table 50 is equal to or larger than a preset first smiling degree threshold value (for example, 75) (S75). Then, the workplace-and-working-hours-proposing program 30 terminates this seventh recommendation-condition-and-score decision processing.

Incidentally, in this seventh recommendation-condition-and-score decision processing a second stress degree threshold value which is smaller than the first stress degree threshold value may be set in advance; and a specified value (for example, “1”) may be added to the recommendation score of the relevant workplace in the recommendation-condition-and-score table 50 with respect to the workplace regarding which the average value of the stress degree calculated in step S72 is equal to or smaller than the second stress degree threshold value.

Similarly, a second smiling degree threshold value which is smaller than the first smiling degree threshold value may be set in advance; and a specified value (for example, “1”) may be subtracted from the recommendation score of the relevant workplace in the recommendation-condition-and-score table 50 with respect to the workplace regarding which the average value of the smiling degree calculated in step S72 is equal to or smaller than the second smiling degree threshold value.

(4-1-1-8) Eighth Recommendation-Condition-and-Score Decision Processing

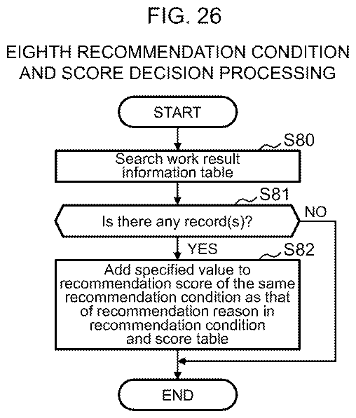

When the workplace-and-working-hours-proposing program 30 terminates the seventh recommendation-condition-and-score decision processing, it starts the eighth recommendation-condition-and-score decision processing illustrated in FIG. 26 and firstly searches for the target user's past workplace information table 25 (FIG. 8) (S80).

Then, the workplace-and-working-hours-proposing program 30 judges whether or not there is one or more records in the past workplace information table 25 detected by the search (S81). Then, if the workplace-and-working-hours-proposing program 30 obtains a negative result in this judgment, it terminates this eighth recommendation-condition-and-score decision processing.

On the other hand, if the workplace-and-working-hours-proposing program 30 obtains an affirmative result in the judgment of step S81, it extracts all the respective recommendation reasons stored in the recommendation reason column of a record for a workplace used by the target user within a specified period of time (for example, within the last five days) in the target user's past workplace information table 25 and updates the recommendation score of the record in which the relevant recommendation reason is stored in the condition column 50B (FIG. 11) of the recommendation-condition-and-score table 50 (882). Specifically speaking, if the same recommendation reason is extracted a plurality of number of times, the workplace-and-working-hours-proposing program 30 adds a specified value (for example, “1”) to the recommendation score of the record in which the relevant recommendation reason is stored in the condition column 50B of the recommendation-condition-and-score table 30, as many times as the number of the extracted recommendation reasons.

Then, the workplace-and-working-hours-proposing program 30 terminates this eighth recommendation-condition-and-score decision processing.

Incidentally, the above-mentioned numerical value added to the recommendation score in step S82 may not be a fixed value and may be set to become smaller as the date stored in the date column 25A (FIG. 8) of a record, in which the relevant recommendation reason is stored in the recommendation reason column 25C (FIG. 8) of the past workplace information table 25, is older by setting, for example, “1” for one day before, “0.8” for two days before, “0.6” for three days before, “0.4” for four days before, and “0.2” for five days before.

(4-1-2) Workplace Selection Processing

Next, an explanation will be provided about specific processing content of the workplace selection processing executed by the workplace-and-working-hours-proposing program 30 in step S3 of the labor support service provision processing described earlier with reference to FIG. 10.

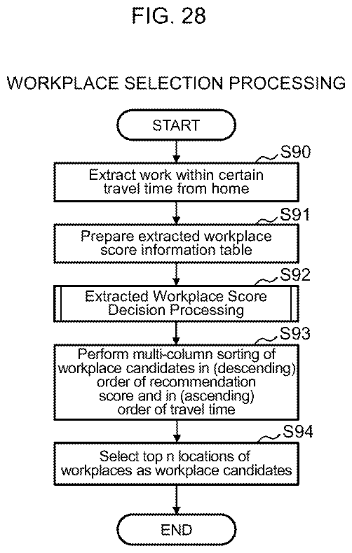

FIG. 28 illustrates specific processing content of the workplace selection processing. When the workplace-and-working-hours-proposing program 30 proceeds to step S3 of the labor support service provision processing, it starts the workplace selection processing illustrated in this FIG. 28, firstly refers to the user management table 20 (FIG. 3) of the target user, and extracts workplaces regarding which the travel time from the target user's home to the relevant workplace is within a certain amount of time (for example, 30 minutes), from among the workplaces available to the target user (S90).

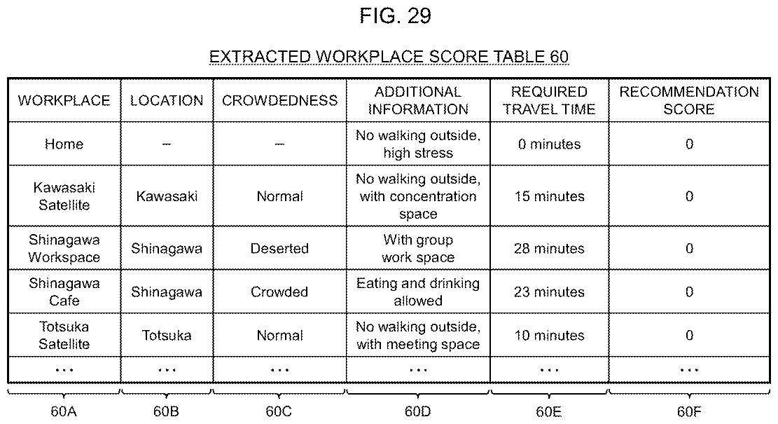

Subsequently, the workplace-and-working-hours-proposing program 30 creates an extracted workplace score information table 60 as illustrated in FIG. 29 which stores information regarding the respective workplaces extracted in step S90 (hereinafter referred to as the “extracted workplaces”) (S91).

As it is apparent from this FIG. 29, the extracted workplace score information table 60 is configured by including a workplace column 60A, a location column 60B, a crowdedness column 60C, an additional information column 60D, a required travel time column 60E, and a recommendation score column 60F. In the workplace score information table 60, one record (one row in FIG. 29) corresponds to one extracted workplace.

Then, the workplace column 60A stores identification information such as the name or the like of the relevant extracted workplace; and the location column 60B stores a station name of the nearest station of the extracted workplace. Moreover, the crowdedness column 60C stores the current crowdedness status of the relevant workplace which is acquired from the external service server 4 of a management company of a facility which is the workplace. FIG. 29 shows that such crowdedness status is evaluated in three levels, that is, “Normal” which is a normal-level crowdedness status, “Crowded” which is more crowded than “Normal,” and “Deserted” which is less crowded than “Normal.”

Furthermore, the additional information column 60D stores information regarding the environment of the workplace such as whether various kinds of spaces exist or not, and whether eating and drinking is allowed or not; and the required travel time column 60E stores the amount of time required to travel from the target user's home to the extracted workplace (travel time). Moreover, the recommendation score column 60F stores a recommendation score for the relevant extracted workplace. All these recommendation scores are set to “0” in the initial state.

Then, when the workplace-and-working-hours-proposing program 30 creates the extracted workplace score information table 60 in the initial state described above, it executes extracted workplace score decision processing for deciding the recommendation score of each extracted workplace by using this extracted workplace score information table 60 (S92).

Specifically speaking, the workplace-and-working-hours-proposing program 30 selects one condition (record) registered in the recommendation-condition-and-score table 50, whose content is finalized through the recommendation-condition-and-score decision processing described earlier with reference to FIG. 12 to FIG. 26, and judges whether each extracted workplace conforms to its condition or not. Incidentally, the expression “conform to” means that the extracted workplace is a target to which the relevant condition should be applied; and more specifically, it means that any one of the “Location (the nearest station),” “Crowdedness,” and “Additional Information” of the extracted workplace includes that condition or any matters related to that condition.

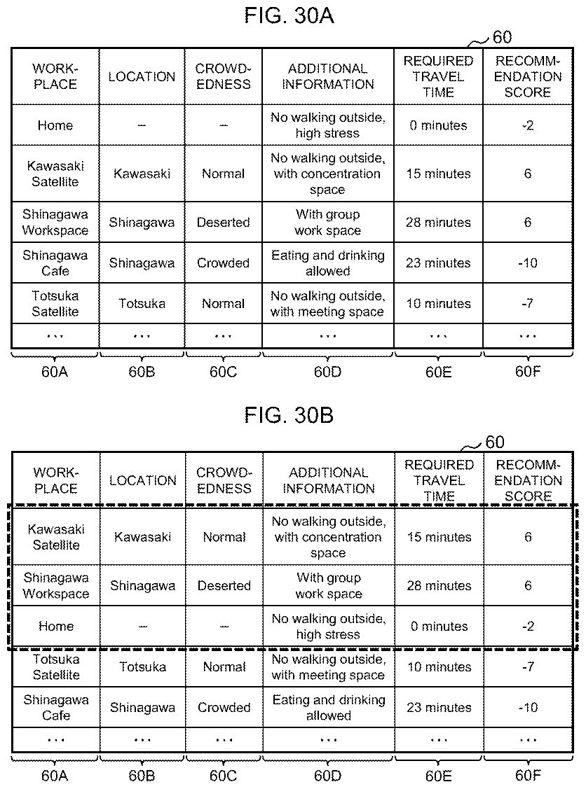

Then, if any one of the extracted workplaces conforms to its condition, the workplace-and-working-hours-proposing program 30 adds the recommendation score for that condition to the recommendation score for the relevant extracted workplace. The workplace-and-working-hours-proposing program 30 decides the recommendation score for each extracted workplace as illustrated in FIG. 30A by executing the above-described processing with respect to all the records in the recommendation-condition-and-score table 50.

Subsequently, the workplace-and-working-hours-proposing program 30 sorts the respective extracted workplaces registered in the extracted workplace score information table 60 in descending order of the recommendation score as illustrated in FIG. 30B and, if the recommendation scores are the same, in ascending order of the required travel time (S93). Then, the workplace-and-working-hours-proposing program 30 selects top n locations (for example, three locations) as workplace candidates from among the respective sorted extracted workplaces (S94), and then terminates this workplace selection processing.

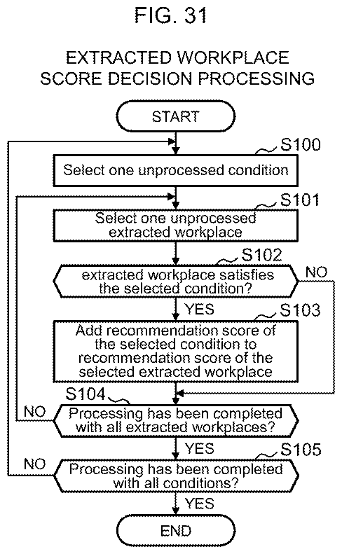

Incidentally, FIG. 31 illustrates a specific processing sequence of the extracted workplace and score decision processing executed in step S92 of the above-described workplace selection processing. When the workplace-and-working-hours-proposing program 30 proceeds to step S92 of the workplace selection processing, it starts this extracted workplace score decision processing and firstly selects one condition regarding which step 101 and subsequent steps have not been processed yet, from among the recommendation/non-recommendation conditions which are then registered in the recommendation-condition-and-score table 50 (S100).

Subsequently, the workplace-and-working-hours-proposing program 30: selects one extracted workplace, regarding which step S102 and subsequent steps have not been processed yet, from among the extracted workplaces registered in the extracted workplace score table 60 (S101); and judges whether or not that extracted workplace conforms to the condition selected in step S100 (hereinafter referred to as the “selected condition”) (S102).

For example, if the selected condition is, for example, a “Concentration Space,” “No Walking Outside,” “Eating and Drinking Allowed,” a “Team Work SpaceTeam Work Space,” or a “Smoking Space” and if the extracted workplace selected in step S101 (hereinafter referred to as the “selected extracted workplace”) has the same additional information as that selected condition, the workplace-and-working-hours-proposing program 30 determines that the selected extracted workplace conforms to the selected condition.

Moreover, if the selected condition is the workplace such as “Home,” “Kawasaki Satellite,” or “Shinagawa Workspace” or the nearest station such as “Shinagawa,” “Kawasaki,” or “Totsuka,” the workplace-and-working-hours-proposing program 30 determines that the selected extracted workplace conforms to the selected condition when that workplace or the nearest station is stored in the “Workplace” or the “Location” of the selected extracted workplace.

Then, if the workplace-and-working-hours-proposing program 30 obtains a negative result in the judgment of step S102, it proceeds to step S104. Moreover, if the workplace-and-working-hours-proposing program 30 obtains an affirmative result in the judgment of step S102, it adds the recommendation score for the selected condition registered in the recommendation-condition-and-score table 50 to the recommendation score for the selected extracted workplace in the extracted workplace score table 60 (S103).

Subsequently, the workplace-and-working-hours-proposing program 30 judges whether or not the execution of the processing from step S102 to step S103 has been completed with respect to all the extracted workplaces (S104). Then, if the workplace-and-working-hours-proposing program 30 obtains a negative result in this judgment, it returns to step S101 and subsequently repeats the processing from step S101 to step S104 by sequentially switching the extracted workplace to be selected in step S101 to another extracted workplace regarding which step S102 and subsequent steps have not been processed yet.

Then, if the workplace-and-working-hours-proposing program 30 eventually obtains an affirmative result in step S104 by finishing executing the processing from step S102 to step S103 with respect to all the extracted workplace, it judges whether the execution of the processing from step S100 to step S104 has been completed or not with respect to all the conditions registered in the recommendation-condition-and-score table 50 (S105).

Then, if the workplace-and-working-hours-proposing program 30 obtains a negative result in this judgment, it returns to step S100 and then repeats the processing from step S100 to step S105 by sequentially switching the condition to be selected in step S100 to another condition regarding which step S101 and subsequent steps have not been processed yet.

Then, if the workplace-and-working-hours-proposing program 30 eventually obtains an affirmative result in step S105 by finishing executing the processing from step S101 to step S104 with respect to all the conditions, it terminates this extracted workplace and score decision processing.

(4-1-3) Working Hours Selection Processing

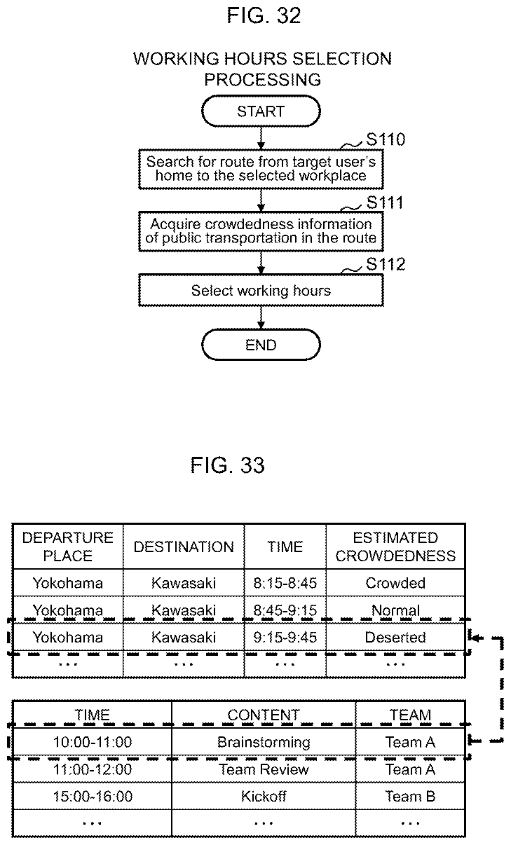

FIG. 32 explains specific processing content of the working hours selection processing executed by the workplace-and-working-hours-proposing program 30 in step S6 of the labor support service provision processing described earlier with reference to FIG. 10.

When the workplace-and-working-hours-proposing program 30 proceeds to step S6 of the labor support service provision processing, it starts the working hours selection processing illustrated in this FIG. 32, firstly accesses an external service server 4 (FIG. 1) of a service provider who provides map information, refers to the user management table 20 (FIG. 3) of the target user, and searches for a route from the target user's home to the workplace selected by the target user (S110).

Subsequently, the workplace-and-working-hours-proposing program 30: accesses a company website of the public transportation which the target user uses for the route detected by the search in step S110 from the target user's home to the workplace selected by the target user; and acquires, as crowdedness information, the current crowdedness status and a future crowdedness forecast of a section of the public transportation from the nearest station of the target user's home to the nearest station of the workplace selected by the target user as indicated in a chart in the upper part of FIG. 33 (S111).

Next, the workplace-and-working-hours-proposing program 30 selects a train whose arrival time at the nearest station is the latest, from among trains whose degree of crowdedness is equal to or lower than “Normal” (“Normal” or “Deserted”) and which are capable of arriving the nearest station of the selected workplace earlier than start time of the target user's today's first work schedule, on the basis of the current and future crowdedness information acquired in step S111, and selects time for that train to travel from the target user's nearest station to the nearest station of the selected workplace as the target user's working hours (a travel time slot for commuting) (S112). Then, the workplace-and-working-hours-proposing program 30 terminates this working hours selection processing.

(4-2) Stress-Degree-and-Smiling-Degree Measurement Processing

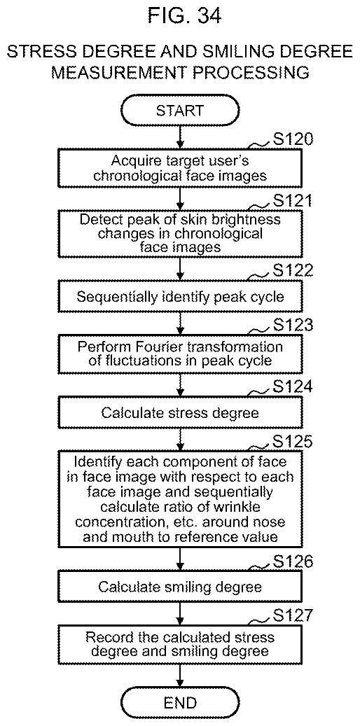

Meanwhile, FIG. 34 illustrates processing content of stress-degree-and-smiling-degree acquisition processing regularly executed by the labor support apparatus after the target user arrives at the workplace selected by the target user or starts working at that workplace. The labor support apparatus 5 acquires the target user's stress degree and smiling degree when working at the workplace according to the processing sequence illustrated in this FIG. 34.

Incidentally, as a means for the labor support apparatus 5 to detect the target user's arrival at the workplace selected by the target user or the target user's start of working at the workplace, for example, it is possible to apply: a method of regularly causing the labor support apparatus 5 send an inquiry to the user terminal 2 of the target user about the current position when the user terminal 2 is equipped with a GPS (Global Positioning System) receiver, and a method of causing the user terminal 2 notify the labor support apparatus 5 of the target user's arrival at the workplace when the user terminal 2 detects it.

Moreover, when the user terminal 2 is not equipped with the GPS receiver, it is possible to apply: a method of registering the target user's start of working in the company use server 3 and causing the labor support apparatus 5 to regularly send an inquiry to the company use server 3 to check whether the target user has started working or not; and a method of causing the company use server 3 to notify the labor support apparatus 5 that the target user's start of working is registered.

Referring back to the explanation of FIG. 34, when the user information management program 28 (FIG. 2) for the labor support apparatus 5 detects that the target user has arrived at the relevant workplace or has started working at that workplace, it starts this stress-degree-and-smiling-degree acquisition processing, for example, every hour, firstly captures a moving image of the target user's face by using the camera device 7 (FIG. 1) and issues an instruction to the user terminal 2 of the target user to transfer the video data, thereby acquiring chronological face images of the target user while working for a certain amount of time (for example, for about three minutes) (S120).

Subsequently, the user information management program 28 sequentially detects peaks of skin brightness changes with respect to the target user's chronological face images acquired in step S120 (S121). Under this circumstance, the maximum brightness during a period of time when the skin brightness of the above-described face images becomes lower than its average value, then exceeds the average value and a specified threshold value (for example, 1.5), and then becomes lower than the average value again is defined as a peak.

Subsequently, the user information management program 28 sequentially measures an amount of time from one peak detected in step S121 to the next peak and sequentially identifies the amount of time obtained by the measurement as a peak cycle of the skin brightness of the face images (S122). This peak cycle can be thought as a pulse cycle of the target user. Specifically speaking, this is because the user's skin brightness rises along with an increase of the blood pressure caused by one-time pulsation and then the user's skin brightness lowers along with a decrease of the blood pressure and, therefore, a cycle of changes in the skin brightness of the face images matches the pulse cycle.

Next, the user information management program 28 transforms fluctuations of the peak cycle into information of a frequency domain by performing the Fourier transformation of the fluctuations of the peak cycle identified as described above (S123).

In the fluctuations of the peak cycle which are transformed into the frequency domain, low frequency components are considered to be components of the peak cycle in a state where parasympathetic nerves are dominant and the target user is a relaxed state; and high frequency components are considered to be components of the peak cycle in a state where sympathetic nerves are dominant and the target user has high stress.

Then, the user information management program 28 calculates a ratio of the high frequency components to the low frequency components as the stress degree of the relevant time slot according to the expression indicated below by recognizing 0.05 Hz to 0.15 Hz of the fluctuations of the peak cycle after the Fourier transformation as the low frequency components and 0.15 Hz to 0A Hz as the high frequency components.

$$\begin{matrix}[ Math . 3 ] & \\ Stress Degree = \frac{Integrated Value of High Frequency Components}{Integrated Value of Low Frequency Components} & ( 3 )\end{matrix}$$

Furthermore, the user information management program 28 recognizes the maximum value of the stress degree of each time slot which has been calculated until the present point in time today as the stress degree until the present point in time today (S124). By applying the above-described calculation method, it is possible to obtain a today's stress degree at the relevant workplace at the stage of having finished today's work.

Subsequently, the user information management program 28 calculates a ratio of, for example, a concentration of wrinkles around a nose and a mouth to a reference value with respect to each of the chronological face images (frame images) acquired in step S120 by making use of the fact that when you smile, the concentration of the wrinkles around the nose and the mouth becomes dense and both an eye's outer corner angle and a mouth corner angle become large (S125). Incidentally, in the processing in step S125, it is assumed that as reference values to judge whether the face image is a smiling face or not, a first reference value is set in advance for the concentration of the wrinkles around the nose and the mouth, a second reference value is set in advance for the eye's outer corner angle, and a third reference value is set in advance for the mouth corner angle.

Specifically speaking, the user information management program 28 firstly utilizes an image recognition model and identifies each of various kinds of components in the face such as eyes, a nose, and a mouth in the relevant face image with respect to one face image regarding which step S121 and subsequent steps have not been processed yet, from among the individual chronological face images acquired in step S120.

Next, the user information management program 28 measures the concentration of the wrinkles around the nose and the mouth, the eye's outer corner angle, and the mouth corner angle, respectively, in the individual face images on the basis of the above-described identification results and calculates a ratio of the concentration of the wrinkles around the nose and the mouth, which is obtained by the measurement, to the first reference value (hereinafter referred to as the “first ratio”), a ratio of the eye's outer corner angle, which is obtained by the measurement, to the second reference value (hereinafter referred to as the “second ratio”), a ratio of the mouth corner angle, which is obtained by the measurement, to the third reference value (hereinafter referred to as the “third ratio”), respectively.

Next, the user information management program 28 calculates a value obtained by multiplying an average value of the first to third ratios calculated as described above by 100, as the smiling degree of the target user of the relevant face image, and sets an average value of the smiling degree respectively calculated for the respective chronological face images acquired in step S120, as the smiling degree of the relevant time slot. Furthermore, the user information management program 28 calculates an average value of the smiling degree of the respective time slots which have been calculated until the present point in time today, as the smiling degree until the present point in time today (S126). By applying the above-described calculation method, it is possible to obtain a today's smiling degree at the relevant workplace at the stage of having finished today's work.

Then, the user information management program 28 stores the stress degree calculated in step S124 and the smiling degree calculated in step S126, together with each piece of information of a today's date and the workplace of the target user, in the stress-degree-and-smiling-degree information table 24 (FIG. 7) (S127), Subsequently, it terminates this stress-degree-and-smiling-degree calculation processing.

### (5) Advantageous Effects of this Embodiment

The labor support apparatus 5 for the labor support system 1 according to this embodiment as described above adjusts the user's set score for each condition previously set by the target user, adds a new condition, selects some optimum workplace candidates for the target user on the basis of the recommendation score for each recommendation condition decided as described above, and proposes them to the target user by executing the first to eight recommendation-condition-and-score decision processing describe earlier with reference to FIG. 12 to FIG. 26.

Moreover, the labor support apparatus 5 selects optimum working hours for the target user on the basis of the current crowdedness status and the future crowdedness forecast of the public transportation, which is used by the target user when traveling to the workplace designated by the target user from among the proposed workplace candidates, and proposes the selected working hours to the target user.

Therefore, this labor support system 1 can propose the workplace and the working hours, which are optimum for the target user, to the target user and thereby support the safe, secured, efficient, and comfortable way of working from the user's point of view.

### (6) Other Embodiments

Incidentally, the aforementioned embodiment has described the case where one server apparatus is equipped with the functions of the labor support apparatus 5; however, the present invention is not limited to this example and, for example, the functions of the labor support apparatus 5 may be distributed to, and located at, a plurality of computer devices which construct a distributed computing system and processing similar to that of the labor support apparatus 5 may be executed by the plurality of computer devices while exchanging information between them as necessary.

Moreover, the aforementioned embodiment has described the case where the value of the user's set score for each recommendation condition is adjusted and a condition is added on the basis of information such as the today's weather information, the service status information of the public transportation, the target user's schedule of the individual work and the team work, the monthly budget and the desired attendance rate of the organization to which the target user belongs, the target user's work efficiency in the past at each workplace, the target user's stress degree and smiling degree in the past at each workplace, and the workplaces selected by the target user in the past; however, the present invention is not limited to this example and, the workplace and the working hours which are optimum for the target user may be selected on the basis of other information in addition to the above-described information.

Furthermore, the aforementioned embodiment has described the case where the workplace-and-working-hours-proposing screen 40 has the configuration as illustrated in FIG. 9; however, the present invention is not limited to this example and a wide variety of other screen configurations can be applied.

Furthermore, the aforementioned embodiment has described the case where the labor support apparatus 5 proposes a plurality of workplaces on the workplace-and-working-hours-proposing screen 40; however, the present invention is not limited to this example and only one workplace candidate may be proposed.

Furthermore, the aforementioned embodiment has described the case where the chronological face images of the target user while working are acquired, for example, for about three minutes in step S120 in FIG. 34; however, the present invention is not limited to this example and the chronological face images of the target user may be continuously acquired for one hour (that is, the acquisition of the face images may be continued continuously during the working hours of the target user). In this case, an amount of computation and a memory capacity which are required for the calculation of the stress degree and the smiling degree become large; however, it is possible to prevent the labor support apparatus 5 from being affected by the above-described increase in the amount of computation and the memory capacity by successively conducting the various kinds of calculation on a real-time basis on the camera device 7 side and on the user terminal 2 side.

### INDUSTRIAL AVAILABILITY

The present invention can be applied to a wide variety of labor support systems with various configurations for proposing the workplace and working hours which are suited for the user.

### REFERENCE SIGNS LIST

1: labor support system
2: user terminal
3: company use server
4: external service server
5: labor support apparatus
7: camera device
9: CPU
20: user management table
21: workplace management table
22: user's set score management table
23: work result information table
24: stress-degree-and-smiling-degree information table
25: past workplace information table
26: weather-condition-based score management table
27: service-status-based score management table
28: user information management table
29: workplace information management table
30: workplace-and-working-hours-proposing program
31: chatbot program
32: chat program
40: workplace-and-working-hours-proposing screen
50: recommendation-condition-and-score table
60: extracted workplace score table

1. A labor support apparatus for supporting a user's labor, comprising:
a workplace selection unit that selects a workplace suited for the user on the basis of an environment and schedule of the user and a work status of the user in past; and
a proposal unit that proposes the workplace selected by the workplace selection unit to the user.

2. The labor support apparatus according to claim 1,
wherein the workplace selection unit selects a travel time slot to travel to the workplace suited for the user on the basis of the environment and the schedule of the user in addition to the workplace; and
wherein the proposal unit selects the travel time slot to travel to the workplace, which is selected by the workplace selection unit, in addition to the workplace selected by the workplace selection unit.

3. The labor support apparatus according to claim 1,
wherein the workplace selection unit selects the workplace suited for the user on the basis of an importance degree which is set by the user in advance to each condition when selecting the workplace suited for the user.

4. The labor support apparatus according to claim 1,
wherein the workplace selection unit selects the workplace suited for the user on the basis of a today's weather condition and/or a service status of public transportation used by the user as the environment of the user.

5. The labor support apparatus according to claim 1,
wherein the workplace selection unit selects the workplace suited for the user on the basis of a schedule of individual work of the user and/or team work performed by a team, to which the user belongs, as the schedule of the user.

6. The labor support apparatus according to claim 1,
wherein the workplace selection unit selects the workplace suited for the user on the basis of an actual result of work efficiency at each workplace available to the user as the work status of the user in the past.

7. The labor support apparatus according to claim 1,
further comprising a user information management unit that measures a degree of stress of the user at work as a stress degree and to what degree the user smiled at work as a smiling degree and records the measured stress degree and the measured smiling degree by associating them with the workplace,
wherein the workplace selection unit selects the workplace suited for the user on the basis of the stress degree and the smiling degree of each workplace recorded by the user information management unit as the work status of the user in the past.

8. A labor support method executed by a labor support apparatus for supporting a user's labor, the labor support method comprising:
a first step of selecting a workplace suited for the user on the basis of an environment and schedule of the user and a work status of the user in past; and
a second step of proposing the selected workplace to the user.

9. The labor support method according to claim 8,
wherein in the first step, the labor support apparatus selects a travel time slot to travel to the workplace suited for the user on the basis of the environment and the schedule of the user in addition to the workplace; and
wherein in the second step, the labor support apparatus selects the travel time slot to travel to the selected workplace in addition to the selected workplace.

10. The labor support method according to claim 8,
wherein in the first step, the labor support apparatus selects the workplace suited for the user on the basis of an importance degree which is set by the user in advance to each condition when selecting the workplace suited for the user.

11. The labor support method according to claim 8,
wherein in the first step, the labor support apparatus selects the workplace suited for the user on the basis of a today's weather condition and/or a service status of public transportation used by the user as the environment of the user.

12. The labor support method according to claim 8,
wherein in the first step, the labor support apparatus selects the workplace suited for the user on the basis of a schedule of individual work of the user and/or team work performed by a team, to which the user belongs, as the schedule of the user.

13. The labor support method according to claim 8,
wherein in the first step, the labor support apparatus selects the workplace suited for the user on the basis of an actual result of work efficiency at each workplace available to the user as the work status of the user in the past.

14. The labor support method according to claim 8,
wherein the labor support apparatus measures a degree of stress of the user at work as a stress degree, measures to what degree the user smiled at work as a smiling degree, and records the measured stress degree and the measured smiling degree by associating them with the workplace; and
wherein in the first step, the labor support apparatus selects the workplace suited for the user on the basis of the stress degree and the smiling degree of each workplace recorded by the user information management unit as the work status of the user in the past.
